(19) United States
(12) Patent Application Publication
(10) Pub. No.: US 2009/0063834 A1
(43) Pub. Date: Mar. 5, 2009

(54) Auto-Switching Bios System and the Method Thereof

(75) Inventors: An-Sheng Huang, Taipei City (TW); Shan-Hua Wu, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INVENTEC CORPORATION, Taipei City (TW)

(21) Appl. No.: 11/850,089

(22) Filed: Sep. 5, 2007

(51) Int. Cl. G06F 15/177

(52) U.S. Cl. 713/2

(57) ABSTRACT

An auto-switching BIOS system and the method thereof, switches to dual BIOS by a hardware control circuit. After the system has been started with the first BIOS to the predetermined period of time and the BIOS_READY signal is detected as disabled, the hardware control circuit switches the system from the first BIOS to the second BIOS and restarts the system with the second BIOS.

### BACKGROUND

1. Field of Invention

The present invention relates to an auto-switching BIOS system and the method thereof. More particularly, the present invention relates the technique of applying a hardware control circuit to auto switch the BIOS to initiate the system.

2. Description of Related Art

In general computer systems, the Basic Input-Output System (BIOS) program is stored in the non-volatile memory, such as the Flash ROM, PROM, EPROM, EEPROM, etc., and the BIOS ROM is installed on the motherboard or included in the system chips to permanently store its content without the influence of the power supply. However, errors still inevitably occur in the BIOS ROM. From time to time, the circuit structure degenerates, or due to irregular operations when updating the BIOS or other unexpected operations causing failures or data loss, thus the system is not able to start up when errors occur in running the BIOS program. So it is important to have a BIOS retrieval and backup of a computer system. In some conventional computer systems, two BIOS memory apparatuses in a computer system or two portions of BIOS data in one BIOS ROM are introduced and switched by software. For switching the BIOS by the software, the content in the initiation section of the BIOS data must be accurate to switch the BIOS to start up a computer. Otherwise the system will still crash during the start-up procedure if data in the initiation section of the BIOS program has collapsed.

### SUMMARY

An auto-switching Basic Input-Output System (BIOS) and the method thereof is provided. An auto-switching Basic Input-Output System comprises a hardware control circuit, a first BIOS program, a second BIOS program, and a switch circuit. The hardware control circuit detects a BIOS_READY signal after the system has been turned on to a predetermined period of time. The BIOS_READY signal is initiated as disabled when the system starts up. So if the BIOS_READY signal is detected disabled, the hardware circuit sends out a switch signal and restarts the system. The first BIOS program and the second BIOS program are applied to initiate the system, wherein the first BIOS program is applied to initiate the system firstly. After one of BIOS programs runs the Power-On Self Test (POST), the BIOS_READY signal is enabled. The switch circuit, which connects to the hardware control circuit, is applied to switch the second BIOS program when receiving the switch signal to initiate the system. Wherein the first BIOS program and the second BIOS program are respectively stored in two separate BIOS ROM, or respectively stored in two separate sections in one BIOS ROM.

The invention also provides a method to auto-switch the Basic Input-Output System (BIOS). The method comprises of initiating a system with a first BIOS program; detecting if a BIOS_READY signal is disabled by a hardware control circuit after the system has been started to a predetermined period of time; sending a switch signal to a switch circuit by the hardware control circuit when detecting the BIOS_READY signal is disabled, and initiating the system with a second BIOS program; and, restarting the system. Wherein the BIOS_READY signal is initiated as disabled when the system starts up, and then after running the Power-On Self Test (POST), the BIOS_READY signal is enabled.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates the first example of the preferred embodiment of this invention;

FIG. 2 illustrates the second example of the preferred embodiment of this invention; and

FIGS. 3A and 3B is a flowchart illustrating the method of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

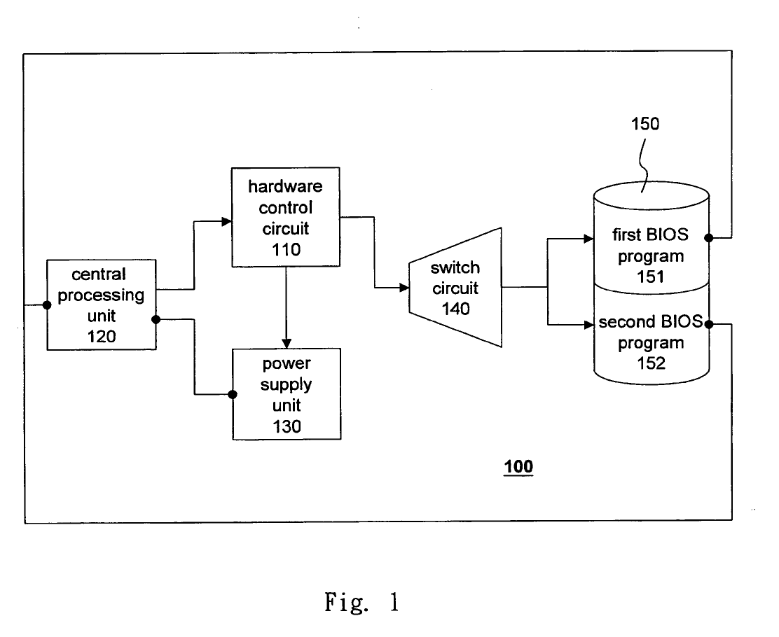

Refer to FIG. 1. FIG. 1 illustrates the first example of the preferred embodiment of this invention. As shown in FIG. 1, the system 100 of auto-switching BIOS comprises a hardware control circuit 110, a central processing unit 120, a power supply unit 130, a switch circuit 140, and a BIOS ROM 150, wherein the BIOS ROM 150 stores the first BIOS program 151 and the second BIOS program 152. The hardware control circuit 110 is a programmable logic integrated circuit. After the system 100 has been started to a predetermined period of time, the hardware control circuit 110 detects the BIOS_READY signal. If the BIOS_READY signal is disabled, the hardware control circuit 110 sends out a switch signal to the switch circuit 140 to restart the system 100, wherein the BIOS_READY signal, which is initiated as disabled when the system starts up, includes every signal transmitted from one of the chips controlled by the central processing unit 120 via chip pins, i.e. General Purpose I/O (GPIO) pins, to the hardware control circuit 110. Further, the first BIOS program 151 and the second BIOS program 152, which are programs for initiating the system, are stored in two separate sections in the BIOS ROM 150, i.e. the 4 MB BIOS ROM separately stores one BIOS program in the address code of 0˜2 MB memory section and a second BIOS program in the address code of 2˜4 MB memory section. The switch circuit 140 connects to the hardware control circuit. When the switch signal is received, the switch circuit 140 switches the address code directed to the BIOS ROM 150 to connect to the first BIOS program 151 or the second BIOS program 152. Thus intended objective of auto-switching BIOS program to start the computer system is accomplished. Moreover, the above-mentioned first BIOS program 151 and second BIOS program 152 are programs comprising a system initiation program, which can be the same program codes or include different program codes for different intentions such as mutual BIOS backup, mutual BIOS retrievals, and virus protections, etc.

Thus, the BIOS_READY signal is firstly initiated as disabled when the system 100 is started and initiated by the first BIOS program 151. And the BIOS_READY signal is then changed as enabled after the Power-On Self Test. Therefore, after the system has been started to a predetermined time period, the hardware control circuit 110 detects whether the BIOS_READY signal is enabled or disabled. If disabled, that is, the BIOS fails to start the system 100, the hardware control circuit 110 sends out a switch signal, BLOCK_SELECT, to the switch circuit 140 to switch the system 100 to connect to the second BIOS program 152, and also send out a system reset signal, SYS_SWITCH_OUT_N ENABLE, to restart the system 100. At that time, the switch circuit 140 modifies the BIOS program address code of the system 100 to initiate the system 100 with the BIOS program 152. So as the above-mentioned technique, it is possible to retrieve the BIOS by amending the program of the hardware control circuit and cooperating to the switch circuit of the auto-switching BIOS system. As in the first example, only one EXCLUSIVE OR Gate is required to achieve the goal. Thus decreasing the manufacturing cost and improving the efficiency of the system operation.

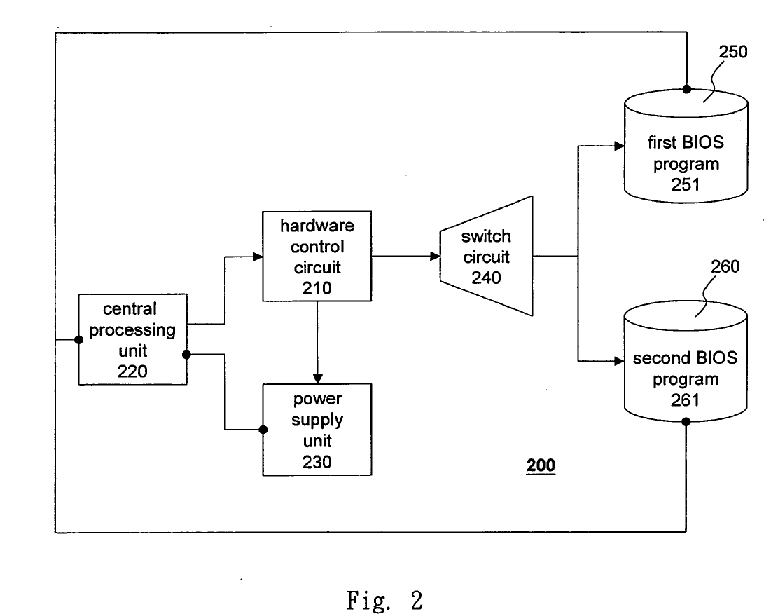

Refer to FIG. 2. FIG. 2 illustrates the second example according to the preferred embodiment of this invention. As shown in FIG. 2, the system 200 of auto-switching BIOS comprises a hardware control circuit 210, a central processing unit 220, a power supply unit 230, a switch circuit 240, and two BIOS ROMs, the first BIOS ROM 250 and the second BIOS ROM 260. The principle of the operation is the same as that in the first example. The only difference when compared to the first example is that the system 200 of the second example has two BIOS ROMs, the first BIOS ROM 250 and the second BIOS ROM 260, which respectively stores the BIOS program 251 and the BIOS program 261. After the system 200 has been started to a predetermined period of time, the hardware control circuit 210 detects the BIOS_READY signal. And if detecting the BIOS_READY signal is disabled, the hardware control circuit 210 sends out a switch signal to the switch circuit 240 to restart the system 200, wherein the BIOS_READY signal, which is initiated as disabled when the system starts up, can be any signals transmitted from one of the chips controlled by the central processing unit 220, via chip pins, i.e. the General Purpose I/O (GPIO) pins, to the hardware control circuit 210. The above-mentioned first BIOS program 251 and second BIOS program 261 are programs comprising a system initiation program, which can be the same program codes or include different program codes for different intentions such as mutual BIOS backups, mutual BIOS retrievals, and virus protections, etc.

Thus, the BIOS_READY signal is firstly initiated as disabled when the system 200 is started and initiated by the first BIOS program 251. And the BIOS_READY signal is then changed as enabled after the Power-On Self Test. Thereafter the BIOS_READY signal is then changed to enabled after the Power-On Self Test. Therefore, after the system has been started to a predetermined period of time, the hardware control circuit 210 detects whether the BIOS_READY signal is enabled or disabled. If disabled, that is, the BIOS of the system 200 fails to start the system 200, and the hardware control circuit 210 sends out a switch signal, BLOCK_SELECT, to the switch circuit 240 to switch the system 200 to connect to the second BIOS program 261, and also sends out a system reset signal, SYS_SWITCH_OUT_N ENABLE signal, to restart the system 200. At the time, the switch circuit 240 modifies the BIOS program address code of the system 200, and initiates the system 200 by the BIOS program 261.

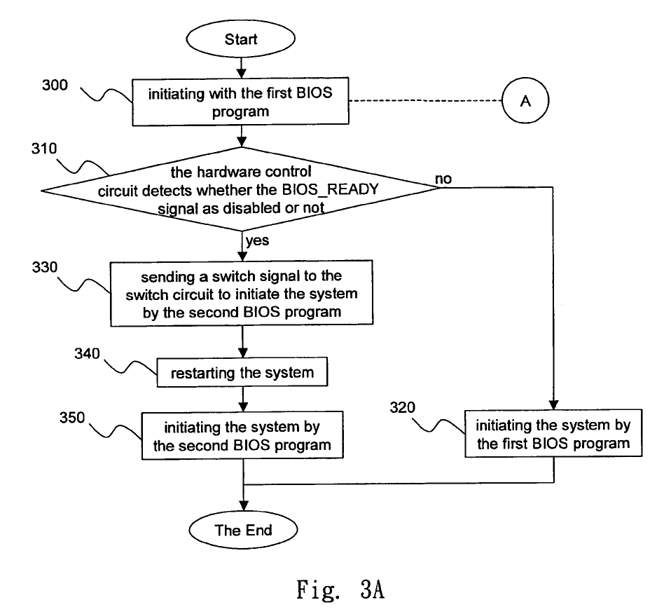

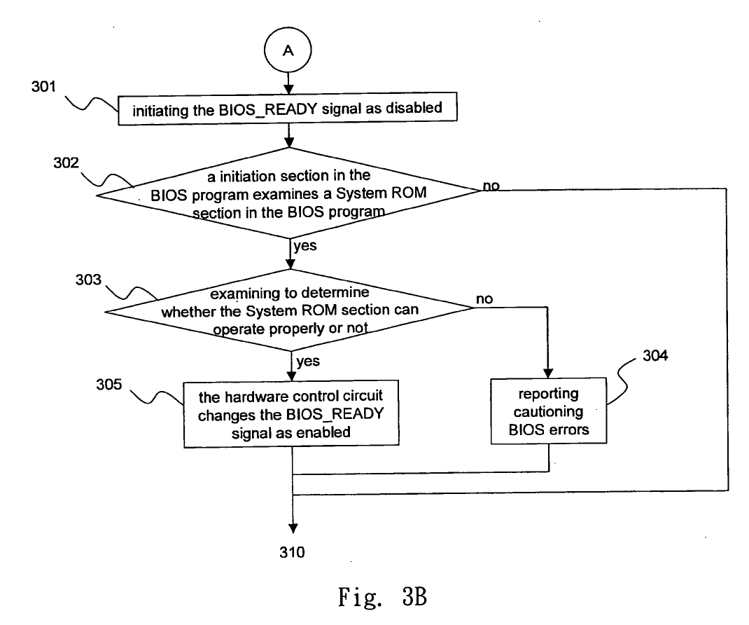

The following reference is made in detail to the present the method of the invention. Refer to FIGS. 3A and 3B. FIGS. 3A and 3B is a flowchart illustrating the method of this invention. For simplifying the description, the first example according to the preferred embodiment of this invention is introduced, but should not be limited to the description of the embodiments contained herein. As shown in FIG. 3A, the system 100 is started and initiated with the first BIOS program 151 (Step 300); then, the hardware control circuit 110 detects whether the BIOS_READY signal as disabled or not after the system 100 has been turned on to a predetermined period of time (Step 310); if the hardware control circuit 110 detects the BIOS_READY signal as enabled in Step 310, the system 100 is started up by the first BIOS program 151 (Step 320); but if the hardware control circuit 110 detects the BIOS_READY signal as disabled in Step 310, the hardware control circuit 110 sends a switch signal to the switch circuit 140 to initiate the system 100 with the second BIOS program 152 (Step 330). After Step 330, the system 100 is restarted (Step 340), and the switch circuit 140 retains the system 100 to be initiated with the second BIOS program 152 (Step 350). Wherein the Step 350 of initiating the system 100 by the second BIOS program 152 further comprises, if the hardware control circuit 110 detects the BIOS_READY signal is disabled after the system 100 has been turned on for a predetermined period of time, the hardware control circuit 110 sends a switch signal to the switch circuit 140 to initiate the system 100 with the first BIOS program 151. Through this, the system 100 is able to auto switch the well-functioned BIOS program to complete the system initiation.

The above-mentioned Step 300 further comprises a detailed Procedure A illustrated in FIG. 3B. As shown in FIG. 3B, procedure A is initiated when the computer system is turned on. At first, the BIOS_READY signal is initiated disabled (Step 301). An initiation section in the BIOS program then examines the System ROM in the BIOS program (Step 302). If the initiation section is not able to examine the System ROM, which means either the BIOS program or the BIOS ROM has failed, and then Step 310 (see FIG. 3A) is initiated. If in Step 302 the initiation section is able to examine the System ROM section, the System ROM section is examined to determine whether it can operate properly or not (Step 303). If in Step 303 the System ROM section is determined to be not operating properly, cautioning BIOS errors are reported (Step 304) and Step 310 (see FIG. 3A) initiated. If the System ROM section is determined to be operating normally, the hardware control circuit 110 changes the BIOS_READY signal as enabled (Step 305), and Step 310 (FIG. 3A) is initiated.

Hence, in the computer system start-up procedure, the first BIOS program initiates the system and runs the Power-On Self Test as the initiation section in the BIOS program examines the System ROM section in the BIOS program. When the System ROM section is estimated accurate, the BIOS_READY signal is enabled. Therefore, after the system has been started to a predetermined period of time, if BIOS_READY signal is detected as enabled by a hardware control circuit, the first BIOS program directly initiates the system. If irregularities occur during the Power-On Self Test, or the initiation section of the first BIOS program itself collapses and is not able to examine the System ROM section, the BIOS_READY signal cannot be enabled. So when the BIOS_READY signal is detected as disabled, the hardware control circuit immediately switches the system to connect to the second BIOS program and restarts the system. And when the system is restarted by the hardware control circuit, the second BIOS program initiates the system. Thus, if the initiation section of one BIOS program doesn't work, or even if one BIOS program or BIOS ROM is completely non-functional, it is possible to auto switch the system to connect to another BIOS program or BIOS ROM to start up.

Although the present invention has been described in considerable detail with reference certain embodiments thereof, other embodiments are possible. Therefore, their spirit and scope of the appended claims should no be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A system of auto-switching Basic Input-Output System (BIOS), comprises:
a hardware control circuit, detecting a BIOS_READY signal after the system has been started for a predetermined period of time, wherein a switch signal is sent out and the system is restarted if the BIOS_READY signal is detected as disabled, and the BIOS_READY signal is initiated to be disabled when the system starts up;
a first BIOS program and a second BIOS program, for initiating the system, wherein the BIOS_READY signal is enabled after one of the first BIOS program and the second BIOS program runs the Power-On Self Test (POST), and the first BIOS program firstly tries to initiate the system; and
a switch circuit, connecting to the hardware control circuit, for switching the second BIOS program to initiate the system when receiving the switch signal.

2. The system of auto-switching Basic Input-Output System of claim 1, wherein the first BIOS program and the second BIOS program are respectively stored in two separate BIOS ROM.

3. The system of auto-switching Basic Input-Output System of claim 1, wherein the first BIOS program and the second BIOS program are stored in two separate sections in one BIOS ROM.

4. The system of auto-switching Basic Input-Output System of claim 1, wherein the hardware control circuit is a programmable logic integrated circuit.

5. The system of auto-switching Basic Input-Output System of claim 1, wherein the BIOS_READY signal includes any one signal controlled by the BIOS.

6. The system of auto-switching Basic Input-Output System of claim 1, wherein the switch circuit retains the system firstly initiated by the second BIOS program when the hardware control circuit restarts the system.

7. A method of auto-switching Basic Input-Output System (BIOS), comprising:
initiating a system by a first BIOS program;
detecting if a BIOS_READY signal as disabled by a hardware control circuit after the system has been started to a predetermined period of time;
sending a switch signal to a switch circuit by the hardware control circuit when detecting the BIOS_READY signal is disabled, and initiating the system with a second BIOS program; and
restarting the system.

8. The method of auto-switching the Basic Input-Output System of claim 7, wherein the BIOS_READY signal is initiated as disabled when the system starts up.

9. The method of auto-switching the Basic Input-Output System of claim 7, wherein the first BIOS program is applied to initiate the system, and after running the Power-On Self Test (POST), the BIOS_READY signal is changed enabled.

10. The method of auto-switching the Basic Input-Output System of claim 7, wherein the second BIOS program is applied to initiate the system, and after running the Power-On Self Test, the BIOS_READY signal is enabled.

11. The method of auto-switching the Basic Input-Output System of claim 7, wherein the first BIOS program and the second BIOS program are respectively stored in two separate BIOS ROM.

12. The method of auto-switching the Basic Input-Output System of claim 7, wherein the first BIOS program and the second BIOS program are stored in two separate sections in one BIOS ROM.

13. The method of auto-switching the Basic Input-Output System of claim 7, wherein the hardware control circuit is a programmable logic integrated circuit, which sends the switch signal to the switch circuit and restarts the system when detecting the BIOS_READY signal disabled.

14. The method of auto-switching the Basic Input-Output System of claim 7, wherein when the switch circuit receives the switch signal, then the system is initiated by the second BIOS program.

15. The method of auto-switching the Basic Input-Output System of claim 7, wherein the BIOS_READY signal comprises every single signal controlled by the BIOS of the system.

16. The method of auto-switching the Basic Input-Output System of claim 7, wherein the step of restarting the system comprises retaining to initiate the system with the second BIOS program by the switch circuit.

17. The method of auto-switching the Basic Input-Output System of claim 16, wherein the step of initiating the system by the second BIOS program, further comprises if the hardware control circuit detects the BIOS_READY signal disabled after the system has been started to a predetermined period of time, sending the switch signal to the switch circuit to initiate the system by the first BIOS program.

18. The method of auto-switching the Basic Input-Output System of claim 7, wherein the step of initiating the system by the first BIOS program, further comprises:
initiating the BIOS_READY signal disabled;
examining a System ROM section in the BIOS program by an initiation section in the BIOS program; and
changing the BIOS_READY signal to enabled when the System ROM section is estimated orderly.

19. The method of auto-switching the Basic Input-Output System of claim 18, wherein the initiation section is the program codes including examining the condition of the System ROM within the BIOS program.

20. The method of auto-switching the Basic Input-Output System of claim 18, wherein the step of examining the System ROM section further comprises cautioning BIOS errors if the System ROM section is estimated disorderly.
